(19) United States
(12) Patent Application Publication
(10) Pub. No.: US 2025/0107867 A1
(43) Pub. Date: Apr. 3, 2025

(54) BANDING SYSTEMS ADAPTABLE TO CONTOURS OF A TOOTH

(71) Applicant: Logan Brown, Dekalb, IL (US)

(72) Inventor: Logan Brown, Dekalb, IL (US)

(21) Appl. No.: 18/374,756

(22) Filed: Sep. 29, 2023

(51) Int. Cl. A61C 5/85

(52) U.S. Cl. CPC A61C 5/85

(57) ABSTRACT

Disclosed herein are novel banding systems that can be used to provide containment of a filling material during treatment of a tooth. In some embodiments, the systems can compensate for missing walls in a tooth to provide containment of a filling material during reconstruction of the tooth. Some embodiments include a system that includes a band. The band includes a plurality of sections and the plurality of sections includes a plurality of support sections and a plurality of elastic sections. In such embodiments, a pair of the plurality of support sections is connected by at least one elastic section of the plurality of elastic sections. And, in such embodiments, the band is configured to fit around side surfaces of a tooth.

### TECHNICAL FIELD

The present disclosure relates to banding systems adaptable to the contours of a tooth.

### BACKGROUND

In dentistry, a matrix or band is a device or system used to compensate for missing walls in a tooth to provide containment of a filling material during reconstruction of such a tooth.

Typically, bands are manufactured from flexible and flat pieces of metal or another durable material. In general, bands are placed around an affected tooth that requires support and containment for reconstruction.

### SUMMARY

Disclosed herein are novel banding systems that can be used to provide containment of a filling material during treatment of a tooth. In some embodiments, the systems can compensate for missing walls in a tooth to provide containment of a filling material during reconstruction of the tooth. Some embodiments include a system that includes a band. The band includes a plurality of sections and the plurality of sections includes a plurality of support sections and a plurality of elastic sections. In such embodiments, a pair of the plurality of support sections is connected by at least one elastic section of the plurality of elastic sections. And, in such embodiments, the band is configured to fit around side surfaces of a tooth. Some embodiments include a system that includes a plurality of support sections and a plurality of elastic sections, wherein a pair of the plurality of support sections is connected by an elastic section of the plurality of elastic sections and the plurality of support sections and the plurality of elastic sections are combined to form a band configured to fit around side surfaces of a tooth. Some embodiments include an apparatus that includes a plurality of support sections and a plurality of elastic sections, wherein a pair of the plurality of support sections is connected by an elastic section of the plurality of the elastic section, and the plurality of support sections and the plurality of elastic sections are combined to form a banding system configured to fit around side surfaces of a tooth.

These and other important aspects of the invention are described more fully in the detailed description below. The invention is not limited to the particular assemblies, apparatuses, methods, and systems disclosed herein. Other embodiments can be used and changes to the described embodiments can be made without departing from the scope of the claims that follow the detailed description.

### BRIEF DESCRIPTION OF THE DRAWINGS

The present disclosure will be understood more fully from the detailed description given below and from the accompanying drawings of various example embodiments of the disclosure.

FIG. 1 illustrates a perspective view of an example banding system, in accordance with some embodiments of the present disclosure.

FIG. 2 illustrates a perspective view of a strap component of an example banding system, in accordance with some embodiments of the present disclosure.

FIG. 3 illustrates a top perspective view of a tooth and the banding system of FIG. 1, in accordance with some embodiments of the present disclosure.

FIG. 4 illustrates another perspective view of the tooth and the banding system of FIG. 3 and it shows a portion of a set of teeth that includes the tooth, in accordance with some embodiments of the present disclosure.

### DETAILED DESCRIPTION

The present disclosure will be understood more fully from the detailed description given below and from the accompanying drawings of various example embodiments of the disclosure.

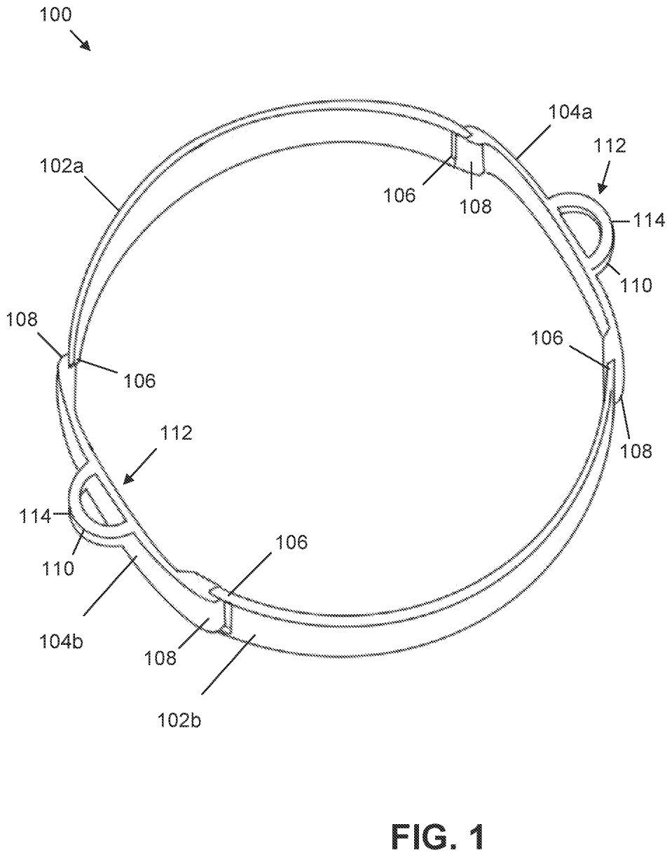

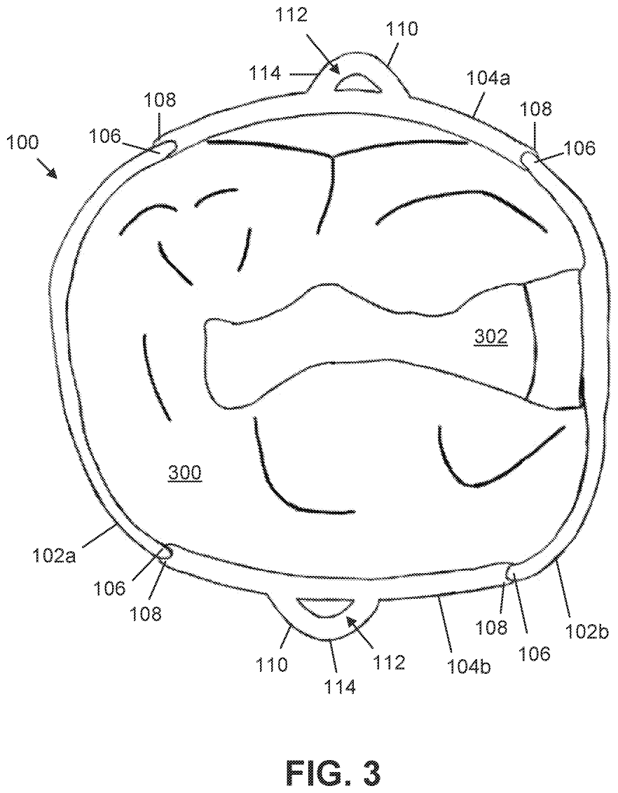

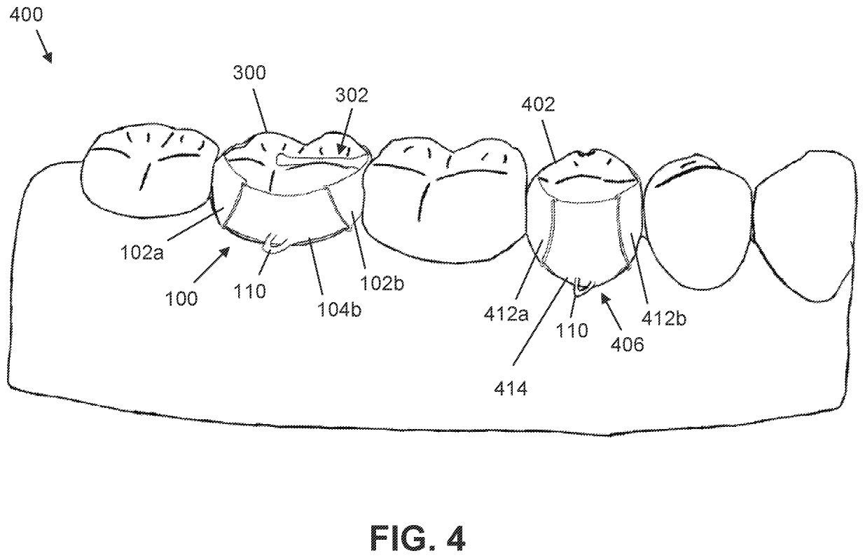

Disclosed herein are novel banding systems (e.g., see systems 100 and 406 shown in FIGS. 1 and 4 respectively) that can be used to provide containment of a filling material during treatment of a tooth. In some embodiments, the systems can compensate for missing walls in a tooth to provide containment of a filling material during reconstruction of the tooth. Some embodiments include a system that includes a band. The band includes a plurality of sections and the plurality of sections includes a plurality of support sections (e.g., see support sections 102a and 102b depicted in FIG. 1) and a plurality of elastic sections (e.g., see elastic sections 104a and 104b also shown in FIG. 1). In such embodiments, a pair of the plurality of support sections is connected by at least one elastic section of the plurality of elastic sections. And, in such embodiments, the band is configured to fit around side surfaces of a tooth (e.g., see FIGS. 3 and 4). Some embodiments include a system that includes a plurality of support sections and a plurality of elastic sections, wherein a pair of the plurality of support sections is connected by an elastic section of the plurality of elastic sections and the plurality of support sections and the plurality of elastic sections are combined to form a band configured to fit around side surfaces of a tooth (e.g., see FIGS. 1 and 3). Some embodiments include an apparatus that includes a plurality of support sections and a plurality of elastic sections, wherein a pair of the plurality of support sections is connected by an elastic section of the plurality of the elastic section, and the plurality of support sections and the plurality of elastic sections are combined to form a banding system configured to fit around side surfaces of a tooth (e.g., see FIGS. 1 and 3).

For the purposes of this disclosure, it is to be understood that a band or a banding system can include a dental matrix. And, in some embodiments, a band or a banding system or a dental matrix can adapt to the anatomical contours of a tooth to aid in the reproduction of missing walls or surfaces when restoring a tooth, e.g., filling a cavity (e.g., see FIGS. 3 and 4). In some embodiments, the dental matrix allows for restorative efficiency and precision as it contains dental materials (e.g., composite, glass ionomer, etc.) to a defined area/outer limit when restoring teeth. In some cases, the systems described herein can include the dental materials to be contained by the matrix, band, or banding system.

As shown in the accompanying drawings, in some examples, the band, banding system, or matrix can include two separate sectional matrices (e.g., two separate stainless steel sectional matrices) connected by two elastic sections that allow the band, banding system, or matrix to adapt around the tooth as a single unit. Thus, it can be positioned in intimate proximity to the restorative workspace, minimizing interference with other anatomical structures (e.g., the cheeks of the patient) that could dislodge the band, banding system, or matrix. This is contrary to known dental matrix systems that have multiple elements that must be assembled separately during a dental procedure. Again, the band, banding system, or matrix can be one unit inserted into the dentition of a patient. Also, as shown in the drawings, in some embodiments, the elastic bands have loops (e.g., see loop structure 114) that allow forceps to engage the band, banding system, or matrix to open it and facilitate placement of it around the tooth. The loops permit the system to be stretched wide enough to fit the specific circumference of the targeted tooth. And, at least the elasticity of the elastic sections (e.g., see elastic sections 104a and 104b shown in FIGS. 1 and 3 as well as elastic section 414 depicted in FIG. 4) facilitate the intimate proximity to the restorative workspace once the system has been fitted around the tooth (e.g., see FIGS. 3 and 4).

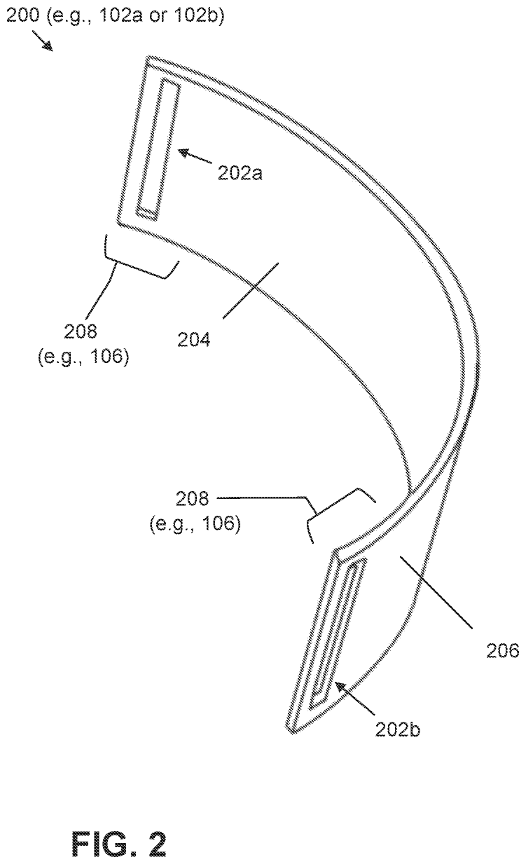

Specifically, FIG. 1 illustrates a perspective view of an example banding system 100, in accordance with some embodiments of the present disclosure. FIG. 2 illustrates a perspective view of a strap component 200 of an example banding system (such as the banding system 100), in accordance with some embodiments of the present disclosure. In some embodiments, the support section 102a or the support section 102b can be the strap component 200. In some embodiments, the support sections 102a and 102b are similar components. And, in some embodiments, the support sections 102a and 102b can each be the strap component 200. FIG. 3 illustrates a top perspective view of a tooth 300 and the banding system 100 in which the banding system is placed around the tooth, in accordance with some embodiments of the present disclosure. FIG. 4 illustrates another perspective view of the tooth 300 and the banding system 100 and it shows a portion of a set of teeth 400 that includes the tooth, in accordance with some embodiments of the present disclosure.

As shown in the accompanying drawings, banding system 100 or somewhat similar embodiments includes four sections that are combined into one unit prior to insertion into dentition of a patient. The four sections include two support sections (e.g., see support sections 102a and 102b) and two elastic sections (e.g., see elastic sections 104a and 104b). As shown, the four sections can be combined via the support-section interfaces of the support sections (e.g., see the support-section interfaces 106) and the elastic-section interfaces of the elastic sections (e.g., see the elastic-section interfaces 108). The two support sections can include two identical semi-circular or at least round sectional matrices with slits near the ends of the sections (e.g., see slits 202a and 202b). The slits are configured as connection interfaces for the elastic sections to connect the support sections and in some examples can be parts of the support-sections interfaces. As shown by FIG. 2, the slits 202a and 202b of the strap component 200 provide an opening in the strap component that extends from an inner side 204 and an outer side 206 of the strap component. Also, as shown, the inner side 204 and the outer side 206 are opposing sides of the strap component 200.

The combination and connection of the four sections provide a single band or a single circular unit. During treatment, the inner side 204 of the strap component 200 can be positioned intimately within proximity to the side walls of a tooth due to the flexibility in the single unit enabled by at least the elastic sections of the unit (e.g., see elastic sections 104a and 104b). Furthermore, during treatment, one or more of the supporting sections (e.g., see strap component 200 or sections 102a and 102b) can be positioned intimately near an anomaly or cavity of the tooth to provide further support for the tooth or to contain restorative dental materials applied to the anomaly or cavity.

And, for example, as shown in FIGS. 1 and 3, the two elastic sections can include two identical elastic sections that can feed through respective openings (such as the slits 202a and 202b) on opposite ends of the two supporting sections (e.g., see the support-section interfaces 106 and the elastic-section interfaces 108). In some embodiments, the elastic sections connect with the supporting sections by forming loops that occur through the openings of the supporting sections and around end portions of the supporting sections (e.g., see the support-section interfaces 106 and the elastic-section interfaces 108 as well as support-section interfaces 208 shown in FIG. 2).

The banding system 100 can be used to provide containment of a filling material during the treatment of a tooth (e.g., see tooth 300 shown in FIG. 3 as well as teeth 300 and 402 depicted in FIG. 4). The system 100 can compensate for missing walls in a tooth to provide containment of a filling material during reconstruction of the tooth. The system 100 includes or forms a band. The band includes a plurality of sections and the plurality of sections includes a plurality of support sections (e.g., see support sections 102a and 102b shown in FIG. 1) and a plurality of elastic sections (e.g., see elastic sections 104a and 104b depicted in FIG. 1). As shown in FIG. 1, a pair of the plurality of support sections is connected by at least one elastic section of the plurality of elastic sections. And, as shown in FIG. 3, the band or the system 100 is configured to fit around side surfaces of a tooth (e.g., see system 100 and tooth 300). As illustrated in FIG. 3, the banding system 100 is being used to provide containment for a filling material to fill a cavity 302 during treatment of the tooth 300. Also, as shown in FIG. 4, the bands or the systems 100 and 406 are being used to provide containment for a filling material, respectively, during treatment of the teeth 300 and 402 depicted in FIG. 4.

Somewhat similarly, some embodiments include a system (e.g., see system 100 or system 406 shown in FIGS. 1 and 4 respectively) that includes a plurality of support sections and a plurality of elastic sections, wherein a pair of the plurality of support sections is connected by an elastic section of the plurality of elastic sections and the plurality of support sections and the plurality of elastic sections are combined to form a band configured to fit around side surfaces of a tooth. Also, somewhat similarly, some embodiments include an apparatus that includes a plurality of support sections and a plurality of elastic sections (e.g., see support sections 102a and 102b shown in FIGS. 1 and 4 as well as support sections 412a and 412b shown in FIG. 4), wherein a pair of the plurality of support sections is connected by an elastic section of the plurality of elastic sections (e.g., see elastic section 104a and 104b shown in FIG. 1 as well as elastic sections 104b and 414 shown in FIG. 4), and wherein the plurality of support sections and the plurality of elastic sections are combined to form a banding system configured to fit around side surfaces of a tooth (e.g., see systems 406).

As shown in FIGS. 1 and 3, in some embodiments, the plurality of support sections includes two support sections consisting of a first support section (e.g., see section 102a) and a second support section (e.g., see section 102b). And, in such embodiments, the plurality of elastic sections includes two elastic sections consisting of a first elastic section (e.g., see section 104a) and a second elastic section (e.g., see section 104b). In some embodiments, the elasticity provided by the plurality of elastic sections allows for the system to be stretched over a tooth and constrict the system around the tooth when seated, to fasten or secure the system into place. In some cases, elastic section can include a loop or grippable feature that allows the operator to insert forceps into the system to be stretched and placed around a tooth.

In some cases, as shown in FIGS. 1 and 3, the first support section is connected to the second support section by the first elastic section and the second elastic section to form the band. Also, as shown in FIGS. 1 and 3, the first support section and the second support section can be made up of similar parts facing each other. Furthermore, as shown in FIGS. 1 and 3, the first elastic section and the second elastic section can be made up of similar parts facing each other.

In some embodiments, at least one of the support sections (e.g., see support section 102a or 102b) includes an inelastic material. In some embodiments, the at least one of the support sections includes a metal. In some cases, the at least one of the support sections includes stainless steel. In some embodiments, at least one of the support sections can be situated between a tooth being worked on and an adjacent teeth next to it (e.g., between the contact points of adjacent teeth). In some embodiments, the support sections are purposefully placed in the interproximal space (such as between the contact point of two adjacent teeth) to allow the operator to burnish metal of the sections with a dental instrument against the adjacent tooth to recreate the contact of the original tooth that is being restored. In some embodiments, at least one of the support sections has an open slit at its ends, allowing at least two elastic components to pass through the section and combine with the overall structure of the system, such the system is combined into one unit. For some examples, wooden wedges can be placed between the adjacent tooth and the system to further secure the system to the tooth being restored.

In some embodiments, at least one of the support sections (e.g., see support section 102a or 102b) includes a curved structure. In some embodiments, the curved structure includes a curved symmetrical structure. In some cases, the curved symmetrical structure is a semicircular structure.

In some embodiments, at least one of the support sections (e.g., see support section 102a or 102b) is flexible. In some other cases, at least one of the support sections is rigid.

In some embodiments, at least one of the elastic sections (e.g., see elastic section 104a or 104b) includes a grippable feature (e.g., see grippable feature 110) configured to be gripped by forceps in placing the band around a tooth. As shown in FIGS. 1 and 3, the grippable feature can include an opening (e.g., see opening 112) configured to facilitate gripping of the grippable feature. Also, as shown in FIGS. 1 and 3, the opening is surrounded by a loop structure that encircles the opening. (e.g., see loop structure 114). In some embodiments, the loop structure is configured to provide for the operator to insert a dental instrument (e.g., rubber dam clamp forceps) through the loop structure to stretch the system over the tooth being worked on. In examples having two elastic sections, the respective loop structures are configured to provide for the operator to insert a dental instrument (e.g., rubber dam clamp forceps) through the loop structures to stretch the system over the tooth being worked on.

In some embodiments, at least one of the elastic sections (e.g., see elastic section 104a or 104b) includes a polymer or an elastic polymeric substance. In some embodiments, the elastic polymeric substance includes latex or a derivative thereof. In some embodiments, the elastic polymeric substance includes nitrile or a derivative thereof. In some cases, the elastic polymeric substance is derived from a plant. In some cases, the elastic polymeric substance is derived synthetically. And, in some examples, at least one of the elastic sections includes rubber.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system, comprising:
a band; and
a plurality of sections of the band, comprising a plurality of support sections,
wherein a pair of the plurality of support sections is connected by an elastic section, and
wherein the band is configured to fit around side surfaces of a tooth.

2. The system of claim 1,
wherein the elastic section is one of a plurality of elastic sections,
wherein the plurality of support sections comprises two support sections consisting of a first support section and a second support section, and
wherein the plurality of elastic sections comprises two elastic sections consisting of a first elastic section and a second elastic section.

3. The system of claim 2, wherein the first support section is connected to the second support section by the first elastic section and the second elastic section to form the band.

4. The system of claim 3, wherein the first support section and the second support section are made up of similar parts facing each other.

5. The system of claim 4, wherein the first elastic section and the second elastic section are made up of similar parts facing each other.

6. The system of claim 3, wherein the first elastic section and the second elastic section are made up of similar parts facing each other.

7. The system of claim 1, wherein at least one of the support sections comprises an inelastic material.

8. The system of claim 7, wherein the at least one of the support sections comprises a metal.

9. The system of claim 8, wherein the at least one of the support sections comprises stainless steel.

10. The system of claim 1, wherein at least one of the support sections comprises a curved structure.

11. The system of claim 10, wherein the curved structure comprises a curved symmetrical structure.

12. The system of claim 11, wherein the curved symmetrical structure is a semicircular structure.

13. The system of claim 1, wherein at least one of the support sections is rigid.

14. The system of claim 1, wherein at least one of the support sections is flexible.

15. The system of claim 1, wherein the elastic section comprises a grippable feature configured to be gripped by forceps in placing the band around a tooth.

16. The system of claim 15, wherein the grippable feature comprises an opening configured to facilitate gripping of the grippable feature.

17. The system of claim 16, wherein the opening is surrounded by a loop structure that encircles the opening.

18. The system of claim 1, wherein the elastic section comprises an elastic polymeric substance.

19. A system, comprising:
a plurality of support sections; and
a plurality of elastic sections,
wherein a pair of the plurality of support sections is connected by an elastic section of the plurality of the elastic section, and
wherein the plurality of support sections and the plurality of elastic sections are combined to form a band configured to fit around side surfaces of a tooth.

20. An apparatus, comprising:
a plurality of support sections; and
a plurality of elastic sections,
wherein a pair of the plurality of support sections is connected by an elastic section of the plurality of the elastic section, and
wherein the plurality of support sections and the plurality of elastic sections are combined to form a banding system configured to fit around side surfaces of a tooth.
